(19) United States
(12) Patent Application Publication
(10) Pub. No.: US 2006/0009992 A1
(43) Pub. Date: Jan. 12, 2006

(54) Method and system for assessing a community's preparedness, deterrence, and response capability for handling crisis situations

(76) Inventors: Mark A. Cwiek, Mt. Pleasant, MI (US); Gerald R. Ledlow, Mt. Pleasant, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 10/884,677

(22) Filed: Jul. 2, 2004

(51) Int. Cl. G06F 17/60

(52) U.S. Cl. 705/1

(57) ABSTRACT

A method and/or system is provided for assessing a community's preparedness, deterrence, and response capability for handling crisis situations. Numerical values representing answers to a series of questions pertaining to a crisis situation preparation domain and a crisis implementation domain are provided. A combined score of the domains is determined based on the numerical values. The combined score is ranked on a scale ranging between poor capability and very good capability for handling crisis situations.

### BACKGROUND

The present invention relates generally to crisis situation preparedness, and more particularly to a method and system for assessing a community's preparedness, deterrence, and response capability for handling crisis situations.

Both somewhat predictable and unpredictable crisis situations arise in the world. From natural disasters, such as floods and hurricanes, to acts of terrorism and war, such as biological and chemical warfare, people and/or communities of people feel the need to be prepared to handle such situations. However, in some instances, it may be difficult to plan for a crisis, especially if the crisis is unpredictable and/or the resources to handle a crisis are not readily available.

### SUMMARY

Embodiments of a method and system for assessing a community's preparedness, deterrence, and response capability for handling crisis situations are disclosed herein. Numerical values representing answers to a series of questions pertaining to a crisis situation preparation domain and a crisis implementation domain are provided. A combined score of the domains based on the numerical values is determined. The combined score is ranked on a scale ranging between poor capability and very good capability for handling crisis situations.

### BRIEF DESCRIPTION OF THE DRAWINGS

Objects, features and advantages of embodiments of the present invention will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a process flow diagram depicting an embodiment of the method;

FIG. 2 is a process flow diagram depicting a further embodiment of the method;

FIG. 3 is an embodiment of the scorecard of the system;

FIGS. 4 through 9 depict embodiments of the categories and questions therein of the scorecard;

FIG. 10 is an embodiment of the scorecard summary depicting the scores and the ranking;

FIG. 11 is an embodiment of a community composite risk assessment table for determining the urgency of action needed;

FIGS. 12A through 12E are an embodiment of a report based on a community's plan for adjusting their preparedness, deterrence, and response capability for handling a crisis situation;

FIG. 13 is a chart depicting an embodiment of a resource requirement sheet; and

FIG. 14 is an embodiment of a capacity worksheet.

### DETAILED DESCRIPTION

Embodiment(s) of the method and system disclosed herein provide a unique and novel way for communities to prepare themselves for expected/somewhat expected and/or unexpected crisis situations. Further, embodiments of the method and system of the present invention advantageously allow a community to assess their current level of preparedness, deterrence and response capability for handling crisis situations. Still further, embodiments of the method and system assist the community in determining a present plan and/or future plan of action for adjusting their level of preparedness, deterrence and response capability in order to be better prepared and equipped to handle crisis situations.

It is to be understood that a crisis situation includes, but is not limited to acts of terrorism/war, natural disasters, and/or outbreaks of disease. It is to be further understood that embodiments of the method and system of the present invention are to assist communities in preparing and planning for crisis situations and are not intended to be considered a replacement for governmental/military directions/directives during such crisis situations.

Yet further, embodiments of the method and system of the present invention advantageously allow a user simultaneously to assess one or more crisis situations and/or simultaneously to assess one or more communities' preparedness, deterrence, and response capability.

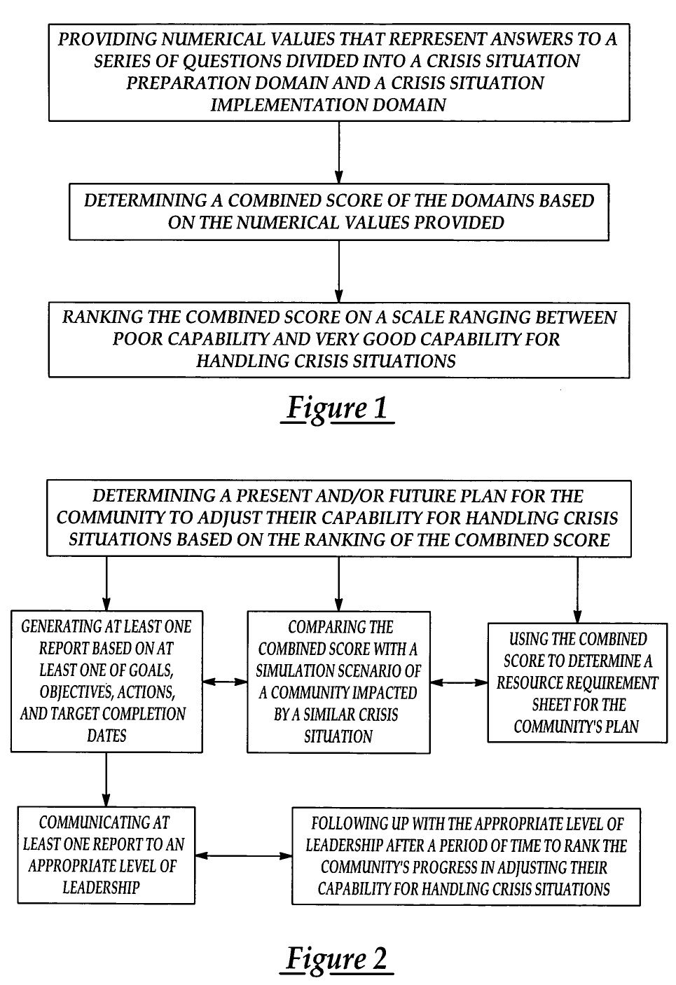

FIGS. 1 and 2 depict flow diagrams of embodiments of the method of the present invention. Generally, an embodiment of the method (as shown in FIG. 1) includes providing numerical values that represent answers to a series of questions, determining a score based on the numerical values provided, and ranking the score on a scale ranging between poor capability and very good capability for handling crisis situations.

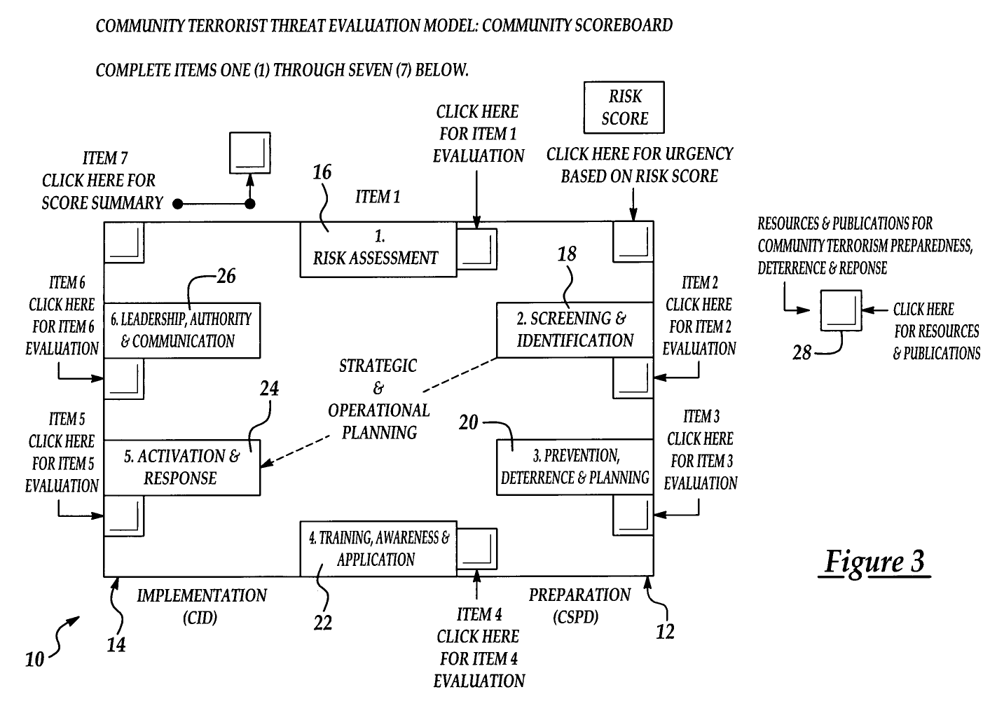

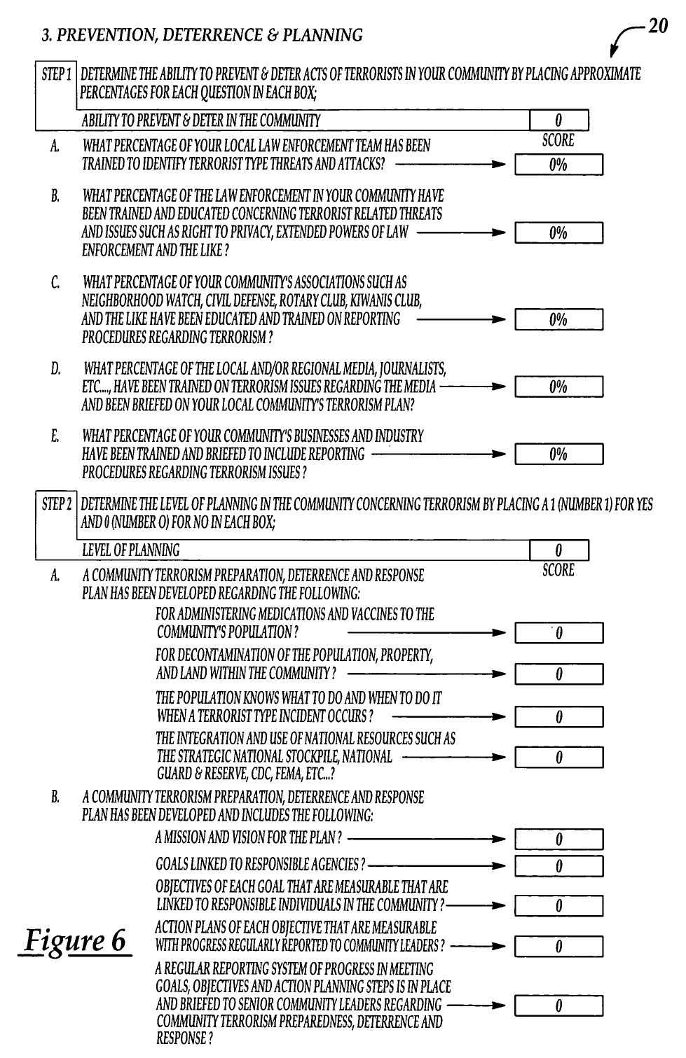

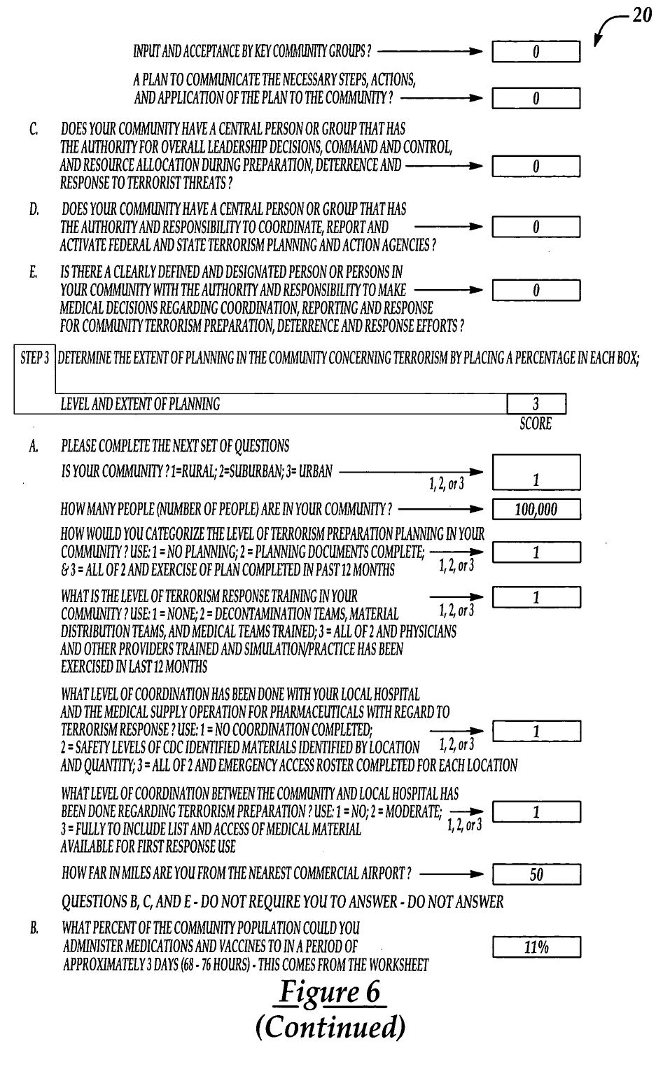

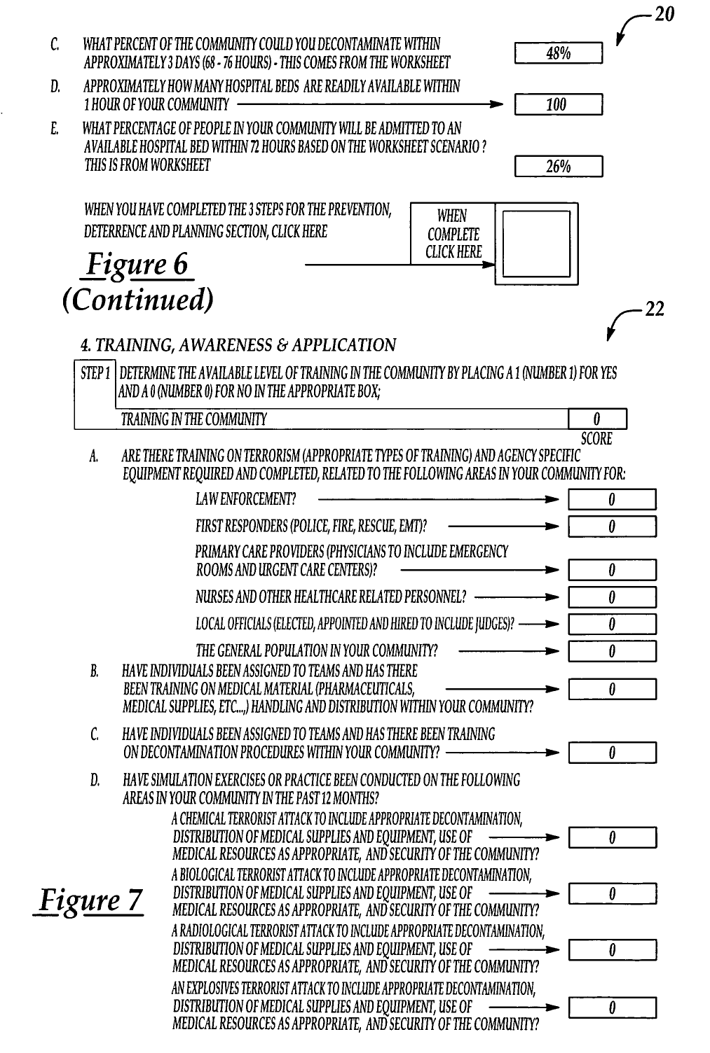

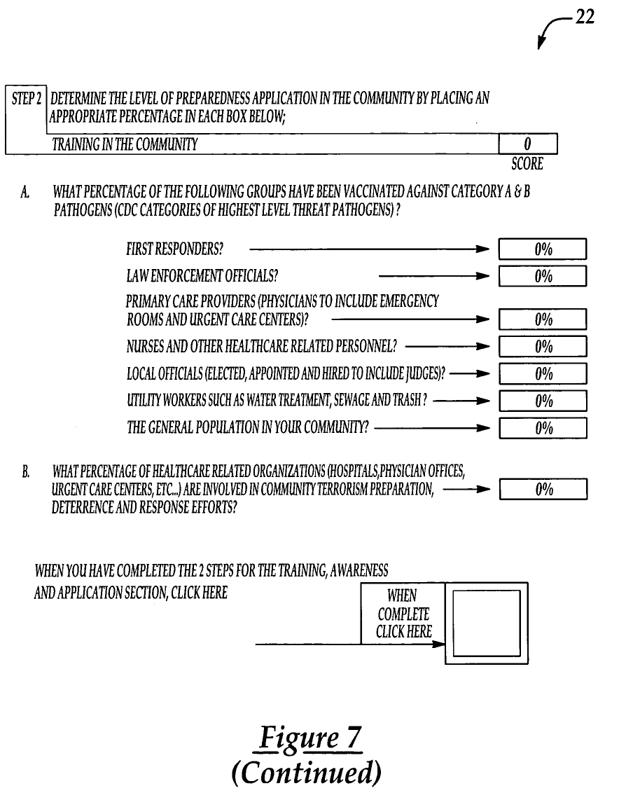

Referring now to FIG. 2, an embodiment of the method optionally includes determining a present plan and/or future plan for the community; reporting goals, objectives, actions and/or target completion dates to an appropriate level of leadership; comparing the score(s) of the community with simulated and/or other like communities and/or past scores of the same community; and/or using the score(s) to determine a resource requirement sheet to assist the community in meeting their goals. Embodiments of the method and the system of the present invention will be discussed in further detail in reference to FIGS. 3 through 14.

Referring now to FIG. 3, an embodiment of the scorecard/analysis scorecard 10 is depicted. It is to be understood that the scorecard 10 may be one part of a system that is used for assessing a community's preparedness, deterrence, and response capability for handling crisis situations. Further, it is to be understood that the system of which the scorecard 10 is a part may be a computer program, an Internet enabled (web-based) program, a program on a compact disc, and/or the like that may be readily usable and/or accessible by a user.

In an embodiment, the scorecard 10 may be divided into two domains, the crisis situation preparation domain (CSPD) 12 and the crisis implementation domain (CID) 14. It is to be understood that each of the domains 12, 14 contains a series of questions pertaining to, but not limited to, the crisis situation(s) being assessed, the community using the system, the community's resources, and/or the community's current level of planning for the crisis situation(s).

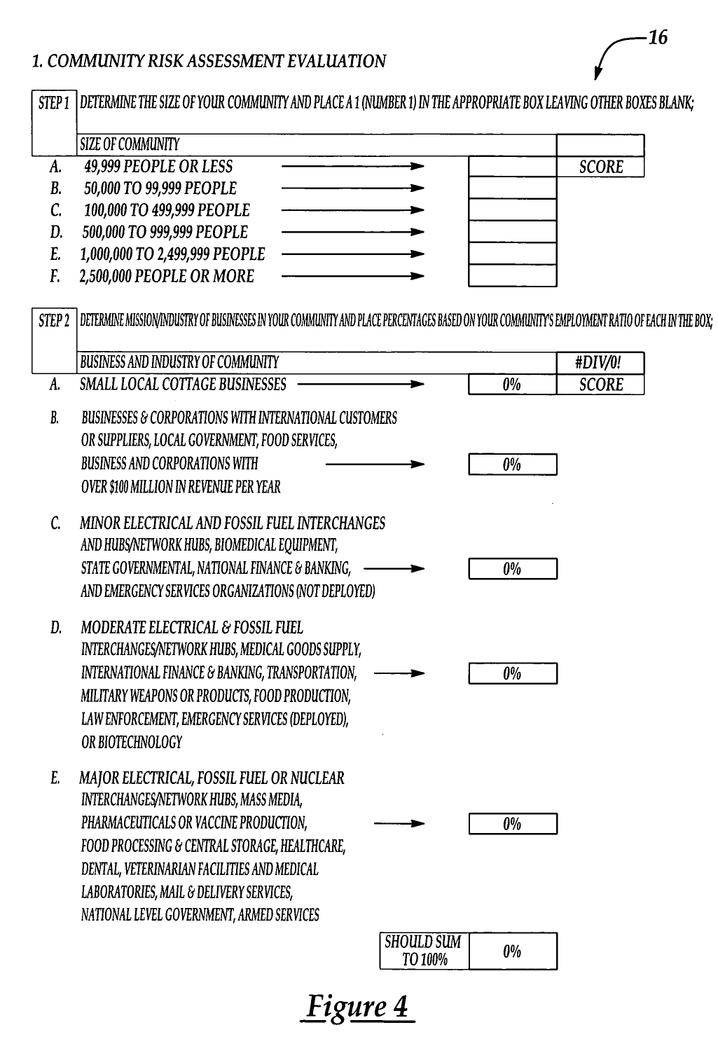

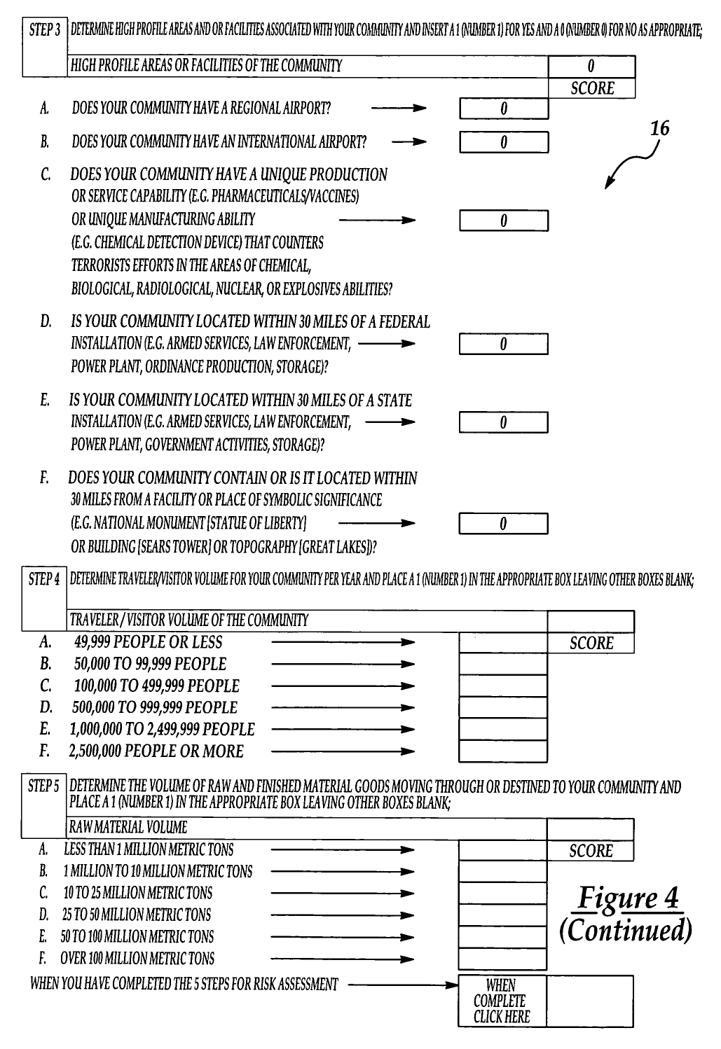

The domains 12, 14 may include categories/dimensions into which the series of questions are divided. Non-limitative examples of the categories that may be included in the CSPD 12 are community risk assessment 16; screening and identification for a potential threat of crisis situations 18; ability to prevent, deter and plan for crisis situations 20; and available level of training, awareness and application in the community 22. For example, the risk assessment category 16 may contain questions about the size of the community, the business and industry of the community, the high profile areas/facilities of the community, the traveler/visitor volume of the community, and/or the raw material volume of the community. FIGS. 4 through 7 depict non-limitative examples of questions that may be included in each of the categories (some sample answers and/or scores are also provided for illustrative purposes). It is to be understood that substantially all of the questions in the CSPD 12 relate to and may assist in determining the community's current level of preparation for and/or ability to deter and/or prevent a crisis situation.

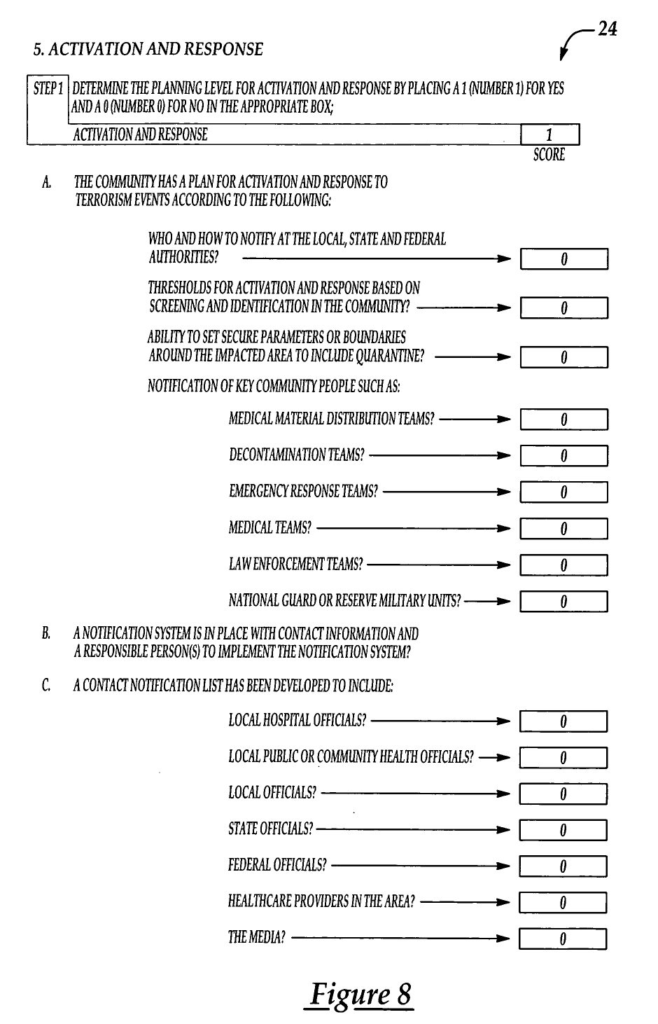

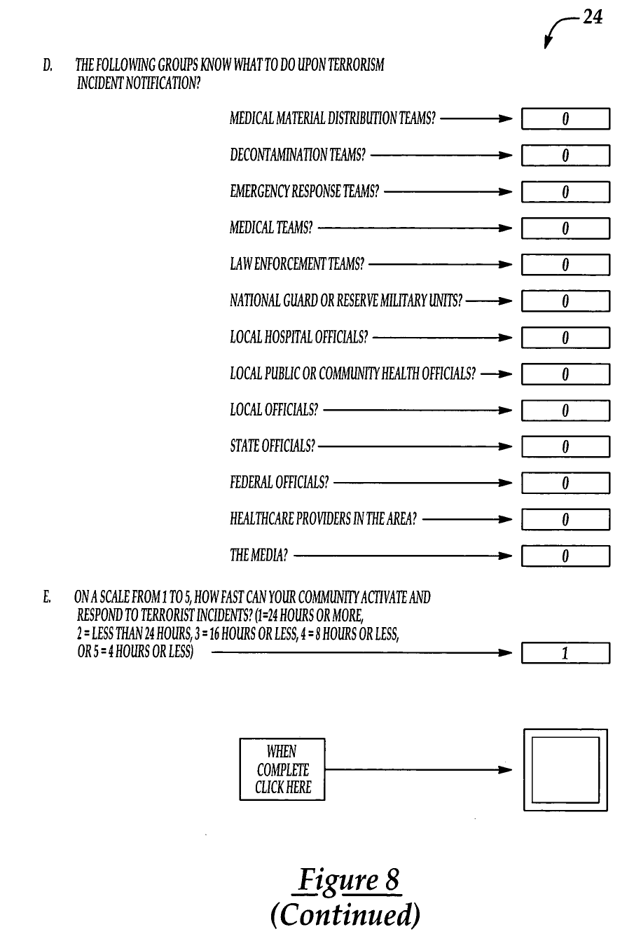

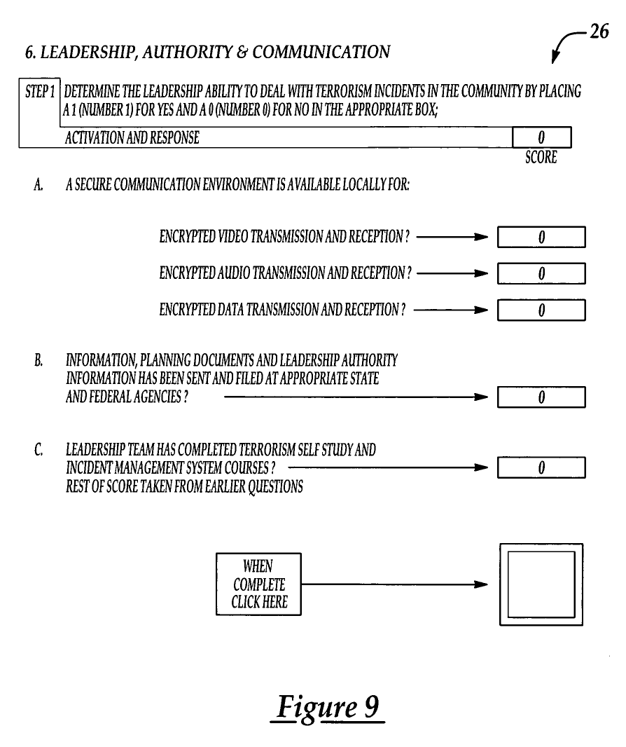

Non-limitative examples of the categories that may be included in the CID 14 are current planning level for activation and response to crisis situations 24, and/or current leadership, authority and communication ability within the community to deal with crisis situations 26. FIGS. 8 and 9 depict non-limitative examples of questions that may be included in each of the categories. It is to be understood that substantially all of the questions in the CID 14 relate to and/or may assist in determining the community's current level of planning and/or leadership ability to handle crisis situations.

As seen in FIGS. 4 through 9, the series of questions may be further divided into steps within each of the categories. Further, each of the questions may pertain to the specific step and/or category in which it is located. Still further, it is to be understood that the questions are designed to assist in determining the community's level of preparation with respect to the specific category.

It is to be understood that the questions may vary depending on the type of crisis situation that is being assessed. For example, the questions as depicted in FIGS. 4 through 9 are directed toward preparedness/deterrence/response capability for acts of terrorism. The series of questions may vary slightly when assessing the preparedness/deterrence/response capability for natural disasters and/or outbreaks of disease.

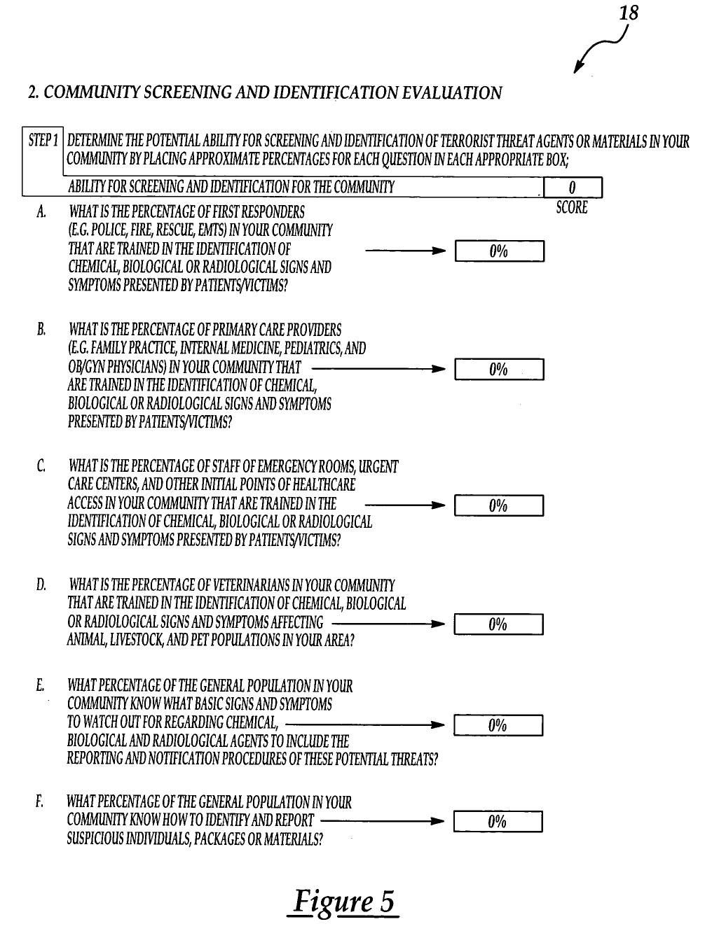

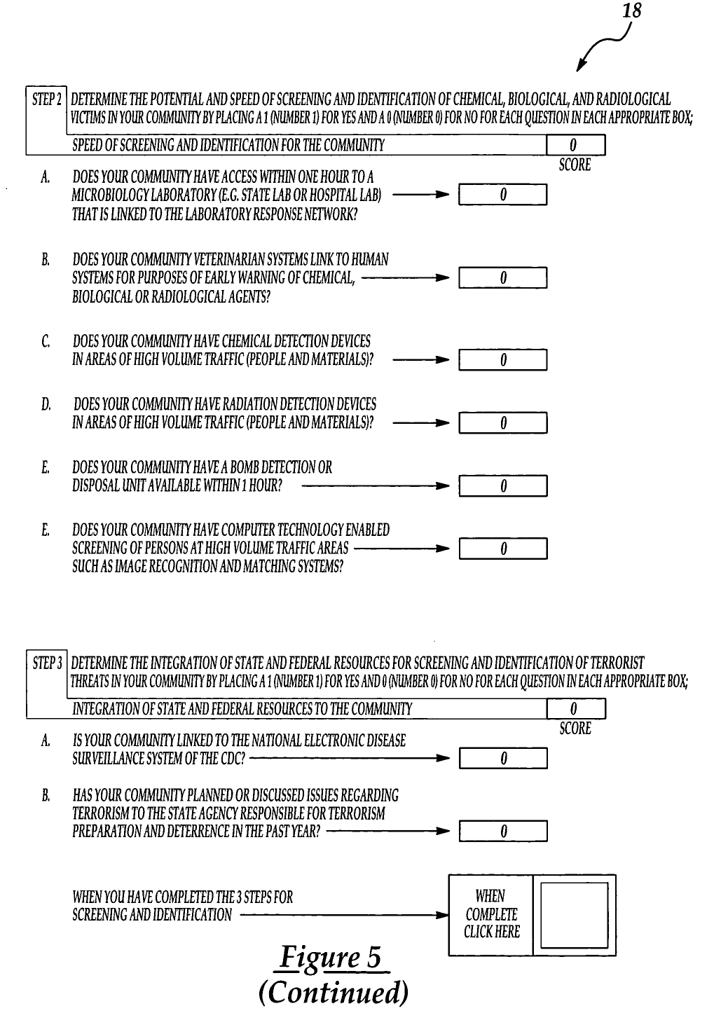

The questions generally require answers that are in the form of a percentage, or a “yes” or “no” response. It is to be understood that the user(s) may answer substantially all of the questions using numerical values. For example, the user may be directed to answer the question with a percentage value (e.g. FIG. 5, Step 1) or, if the question requires a yes or no response, the user may be directed to use a “1” to answer “yes” and a “0” to answer “no” (e.g. FIG. 5, Step 2).

If a user needs assistance in answering the questions (e.g. needs to perform research), a non-limitative embodiment of the system may optionally provide a link/module to various resource and publication materials. The link/module may optionally be advantageously and conveniently accessed via the scorecard 10.

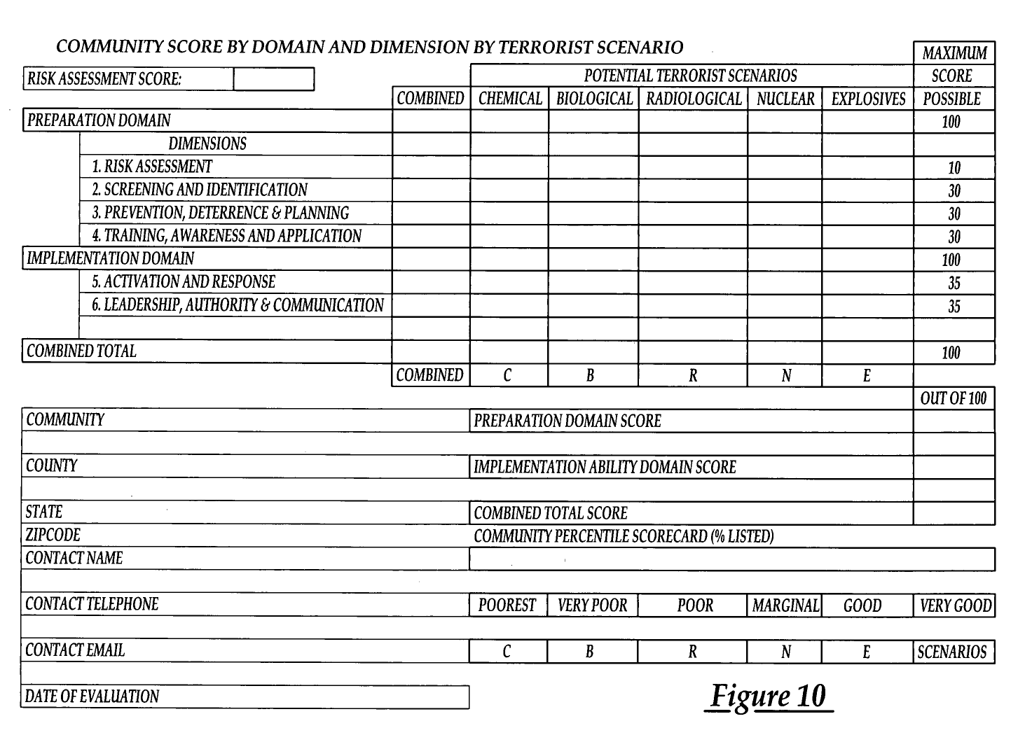

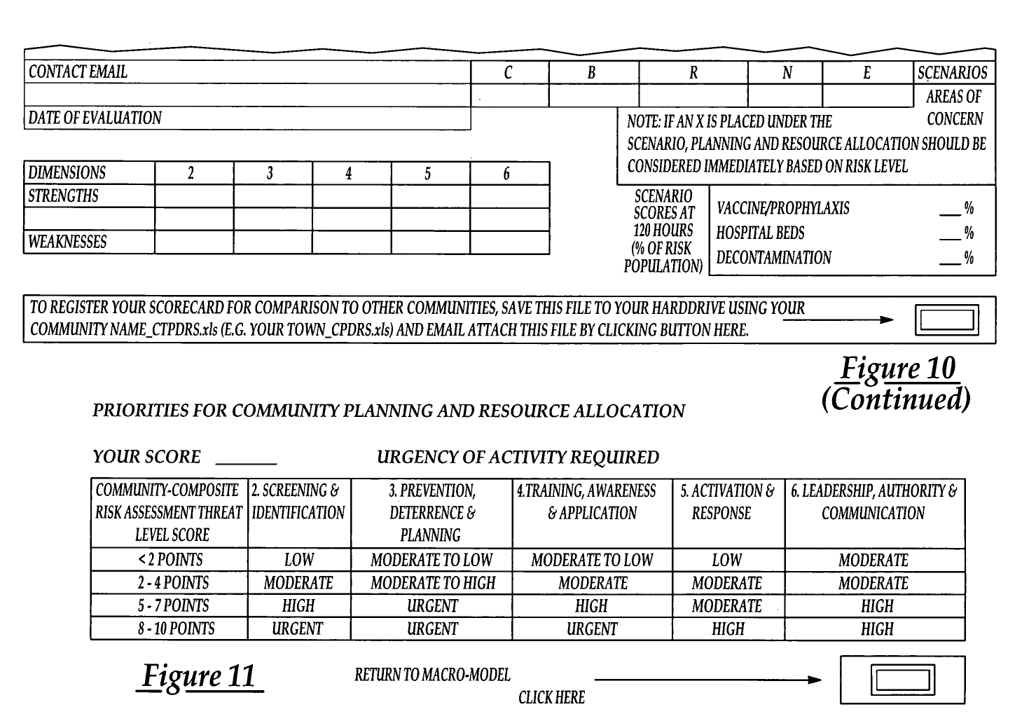

In an embodiment, the scorecard 10 is adapted to receive the numerical values that represent the answers to the questions. Using the numerical values, the scorecard may determine an individual score for: each of the steps within the categories, the categories themselves, and the domains 12, 14; and an overall combined score. The individual scores for the categories and the domains 12, 14, and the combined score are all summarized in a scorecard summary sheet as depicted in FIG. 10. In an embodiment, the system is run via a computer (a processor and a memory) and the scorecard within the system (e.g. a program on a compact disc) is adapted to calculate the scores based on the answers that the user provides.

In a non-limitative embodiment, to calculate the individual and final scores, the scorecard 12 may be configured to multiply each answer to a weight for each crisis situation being assessed. For example, if both a chemical warfare crisis situation and a radiological warfare crisis situation are being assessed, one question may ask, “do you have chemical screening equipment?” A “yes” answer would require, for example, a “1” to be inputted into the scorecard 10 by the user. The scorecard 10 may then multiply this answer to a weight (e.g. 1) for the chemical warfare crisis situation assessment. In this example, however, the scorecard 10 may multiply the answer to this same question to a lower weight for the radiological warfare crisis situation. The weight used may be dependant, in part, on the relationship of the question to the crisis situation being assessed (e.g. chemical warfare and chemical screening equipment are linked). It is to be understood that while the weights multiplied to the numerical answers may be the same, similar or different from each other, each question is multiplied to a weight. Based on these weighted “answers,” the scorecard 10 may then be adapted to calculate an individual score for each step within the category and to calculate an individual score for that particular category. It is to be understood that each category score may be calculated by adding together the weighted answers within that particular category, and then dividing that number by a denominator.

The scorecard 10 may then add the scores from each of the categories within a particular domain 12, 14 to obtain an aggregate score for that domain 12, 14. The aggregate domain score may then be divided by a denominator to achieve a final domain score (ranging between 0 and 100) as may be reported in the scorecard 10. The final score may then be calculated based on a combination (e.g. an average) of the individual final domain scores.

It is to be understood that all of the scores (step score, category scores, domain scores, and the final combined score) have a maximum number and thus are weighted or calculated (where appropriate) accordingly. In a non-limitative example, the maximum score for each of the domains 12, 14 is 100 and the maximum score for the final combined score is also 100. Therefore, in order to calculate a final score that has a maximum of 100, an average of the domain scores may be used.

Referring specifically to FIG. 10, an embodiment of the scorecard summary sheet is depicted for a crisis situation based on terrorism (e.g. chemical warfare, biological warfare, radiological warfare, nuclear warfare, and explosive warfare). The scorecard summary sheet estimates the community's preparedness, deterrence, and response capability for the crisis situation being assessed as of the date the scorecard 10 is filled out. In this embodiment, each of the categories and the domains 12, 14 have a maximum possible score. Each domain score ranges between 0 and 100 with a higher value representing a better capability level. Further, the combined score (based on the domain scores) also ranges between 0 and 100 with a higher value representing a better capability level.

In an embodiment of the method, the combined score may be ranked on a scale for determining the community's capability for handling crisis situations. The scale may range between poorest capability<very poor capability<poor capability<marginal capability<good capability<very good capability, with 0 representing the “poorest” level, 100 representing the “very good” level, and the remaining values falling somewhere in between. It is to be understood that the scorecard 10 may be adapted to calculate (described hereinabove) and record the scores on the summary sheet and to determine where on the scale the particular community ranks.

The scorecard summary sheet may also provide information regarding the community's strengths and weaknesses in each of the categories/dimensions. Still further, the scorecard summary sheet may include a micro simulation designed to estimate the percentage of the people in the community that the community could manage given the population, resources, training, and planning at about 120 hours from the start of a simulated crisis situation. In a non-limitative example, the micro simulation estimates throughput (e.g. number of individuals processed) for decontamination, vaccination, and prophylaxis, and also estimates the number of hospital beds needed. It is to be understood that this estimation may be based on a general simulation and thus may not be scenario-specific.

In a further embodiment, the scorecard summary sheet may designate specific categories that may be of concern for the community. After filling out the scorecard, an “X” or other mark may appear by a particular crisis situation on the summary sheet. The mark may alert a user that planning and/or resource allocation for the designated category may be considered a top priority based on the risk level as determined by a community composite risk assessment table. FIG. 11 illustrates a community composite risk assessment table in which the user may determine which categories/dimensions require substantially immediate attention and/or planning. In making this determination, the user may compare the score from the risk assessment category 16 to the points and levels allocated in the table. For example, if a community scored a “6” in the risk assessment category 16, the urgency of activity for screening and identification 18 would be “high;” while the urgency of activity for prevention, deterrence, and planning 20 would be “urgent.”

After the scorecard 10 generates the summary sheet, the user(s) may then use the combined and/or individual scores to determine a present plan and/or future plan(s) for their community to adjust their capability for handling crisis situations. In an embodiment, the present plan and/or future plan(s) may be based on strengthening the weaknesses of the community, for example, those areas on the scorecard with low(er) scores.

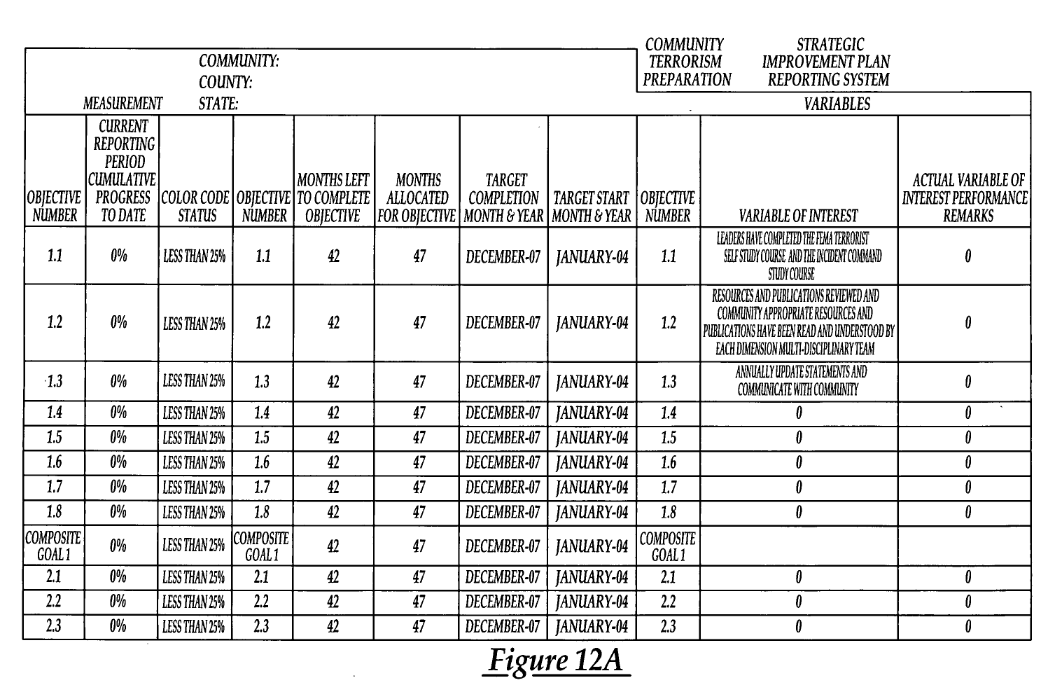

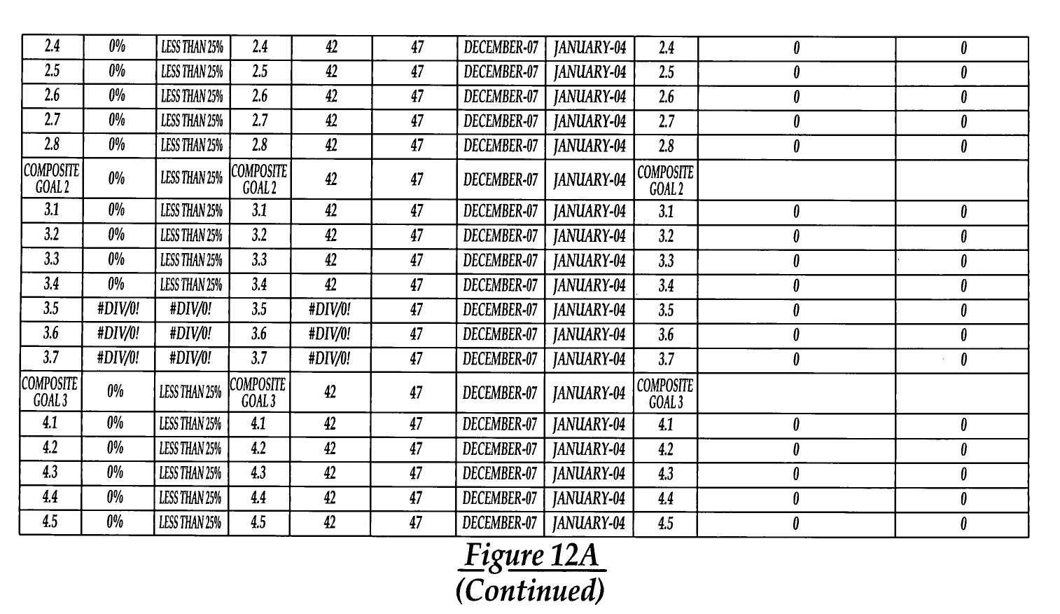

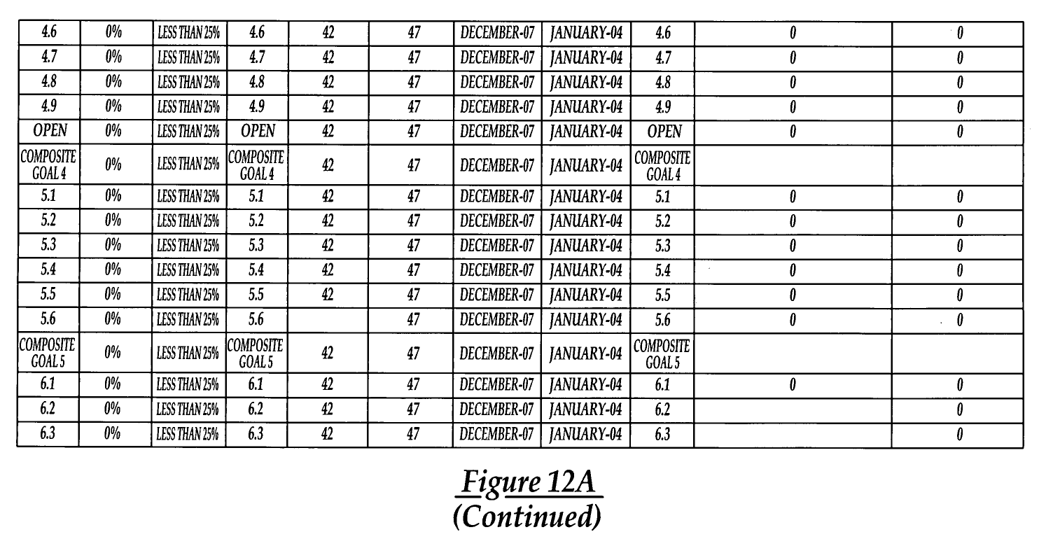

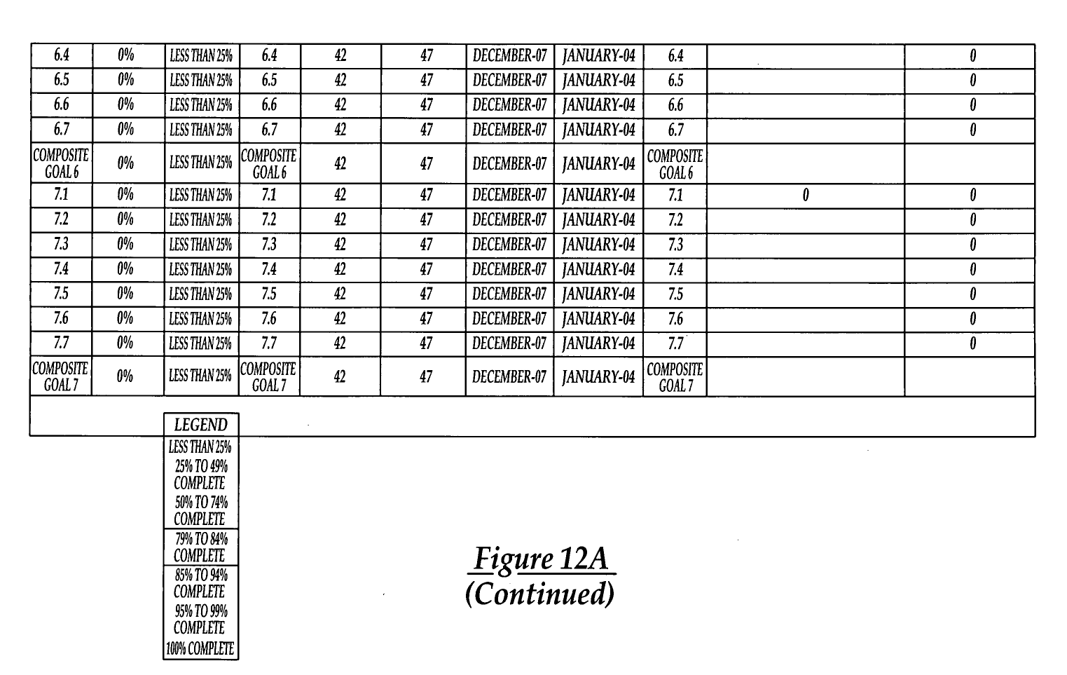

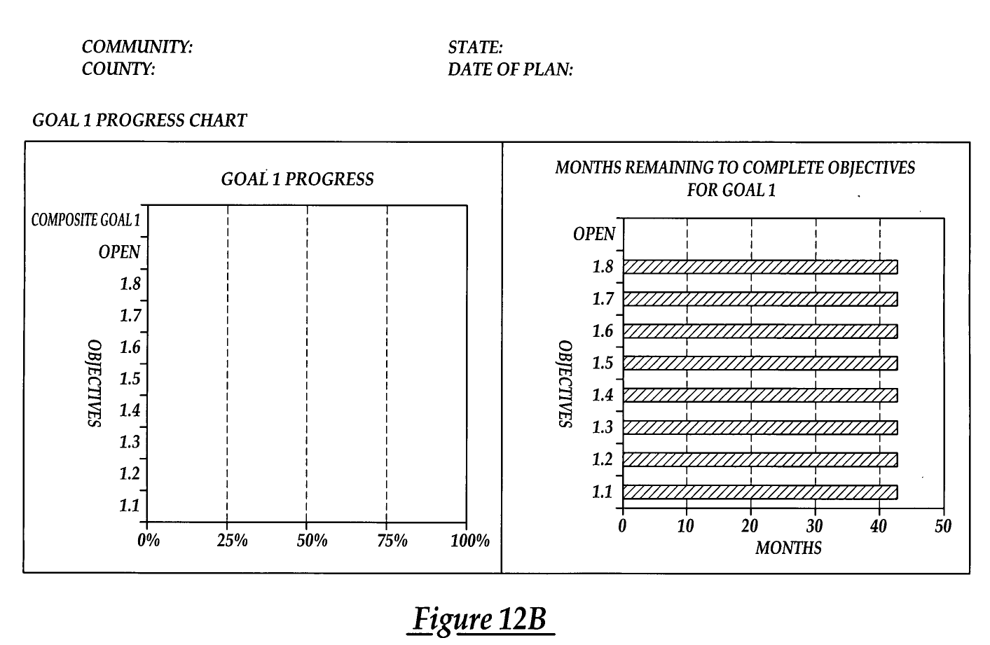

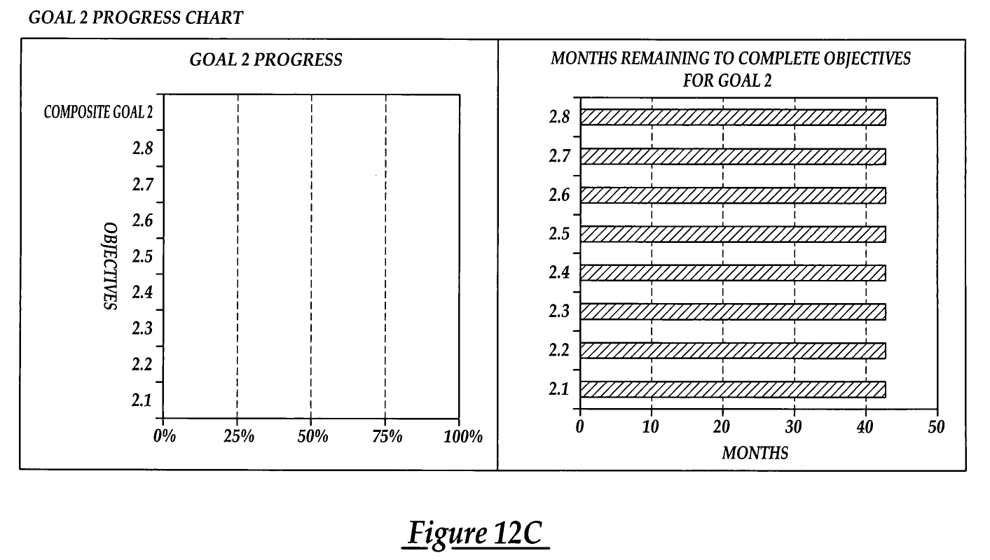

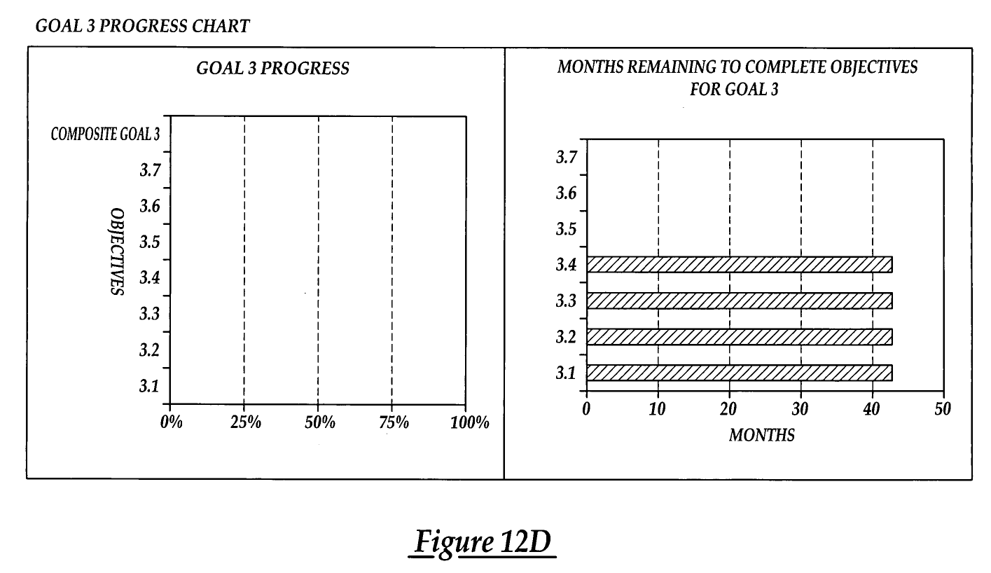

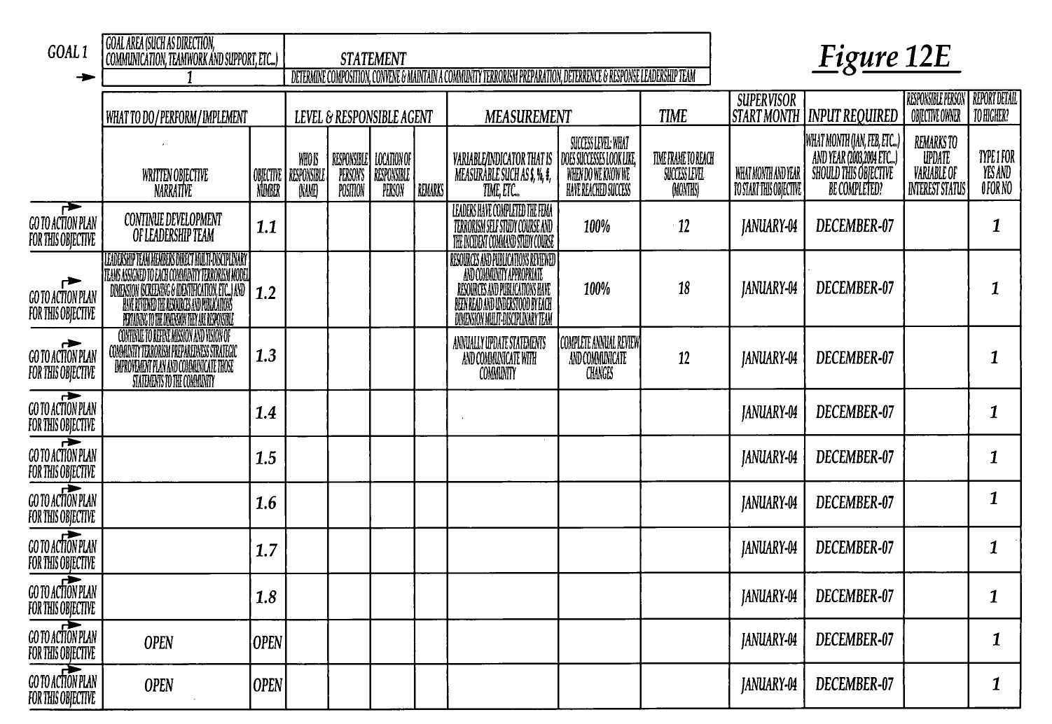

In an embodiment, the present plan and/or future plan(s) include, but are not limited to the community's short and/or long term objectives, short and/or long term goals, actions to be taken, target start and/or completion dates, and/or the like. After the community determines its present plan and/or future plan(s), it may generate one or more report(s), as depicted in FIGS. 12A through 12E, organizing the details of the plan. As depicted in the Figures, the report may include, but is not limited to charts, graphs, and/or spreadsheets that outline the plan and/or records the progress of the community in fulfilling/implementing the plan. It is to be understood that the community members may use the report to keep themselves on schedule with their plans(s), progress, and/or adjustments.

In an embodiment of the method, the community and/or user of the system may also communicate the report(s) to one or more appropriate level(s) of leadership/authority. Suitable examples of appropriate levels of leadership include, but are not limited to police personnel, fire fighters, medical professionals, hospital personnel, public health officials, emergency response/rescue teams, and/or government officials. It is to be understood that by communicating the report(s) to an appropriate level of leadership, the leadership may work with the community to implement and/or oversee the implementation of the present plan and/or future plan(s) to adjust/increase the community's level of preparedness, deterrence, and response capability for handling crisis situations.

The community may follow up with the appropriate level(s) of leadership; or the appropriate level of leadership may follow up with the community after a period of time has passed since the present plan and/or future plan(s) was/were initiated. This may be done in order to check and/or rank the community's progress in obtaining its objectives, reaching its goals, meeting its target dates and/or adjusting its capabilities for handling crisis situations.

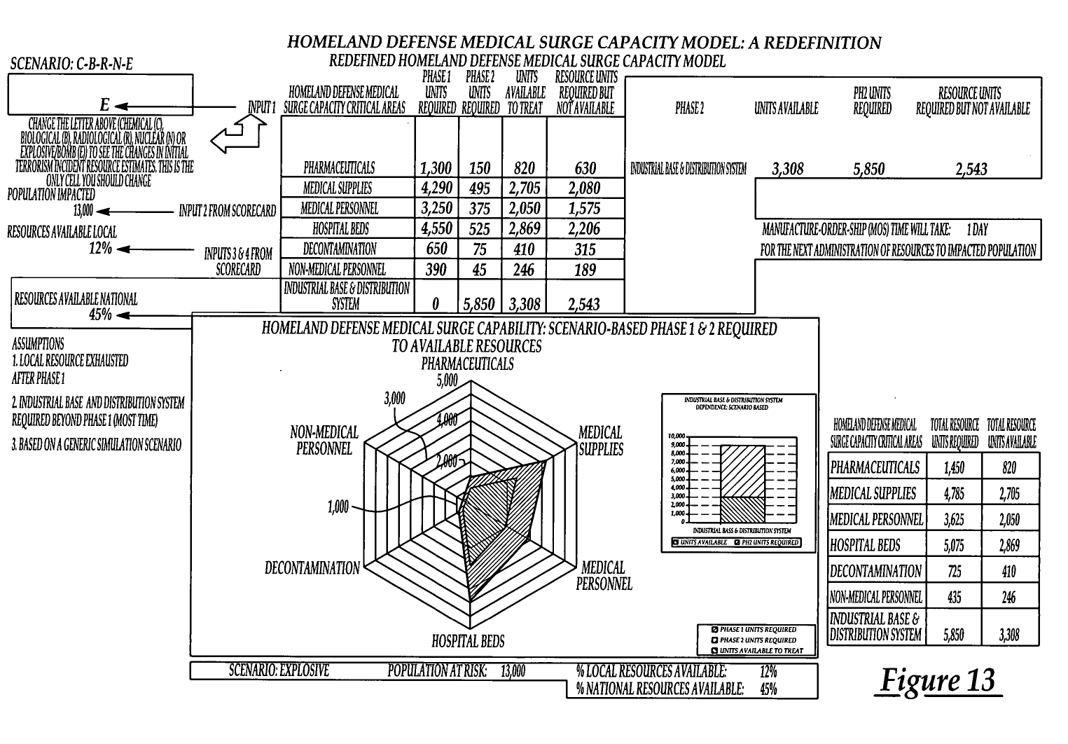

In addition to formulating a present plan and/or future plan(s), the community may also determine a resource requirement sheet (to assist them in their planning) using an embodiment of the system of the present invention. The system may optionally include a macro resource module, which takes some of the information from the scorecard 10 and generates the resource requirement sheet showing the possible and/or probable impact on the quantity of resources in the user's community if such a crisis were presently to occur. It is to be understood that the module may be scenario specific. When a user changes the crisis situation being assessed (by indicating that situation in a particular box on the module), the module may be adapted to readjust the resource requirements based on the situation being assessed and the information in the scorecard 10. It is to be understood that the community may use the resource requirement sheet as a tool in formulating their present plan and/or future plan. An example of a resource requirement sheet is depicted in FIG. 13. In FIG. 13, the macro resource module is based upon six basic resource needs to deal with medical surge capacity needs for the community.

To further illustrate embodiment(s) of the present invention, the following example is given. It is to be understood that this example is provided for illustrative purposes and is not to be construed as limiting the scope of embodiment(s) of the present invention.

### EXAMPLE

The following example is based on the fictional City of Townsville, State of Independence, U.S.A. The system used in this example was for assessing Townsville's preparedness, deterrence, and response capability for handling acts of terrorism, including chemical warfare (C), biological warfare (B), radiological warfare (R), nuclear warfare (N), and explosives (E). This example includes an introductory “community information” page, the scorecard, and the scorecard summary sheet.

The following is an example of a completed community information page. It is to be understood that this page of the system may also include, but is not limited to links/modules to resources and publications, instructions on how to use the system, and/or links to the scorecard.

| Step 1 | Community Information | | |
|---|---|---|---|
| A. | This is the community for | Community Name | Townsville, Independence, USA |
| | the scorecard and analysis | | |
| | (Village, Town, City, or | | |
| | County) | | |
| | | This Community is Located | |
| | | in the: | |
| B. | | County of | Freedom |
| C. | | State of | Independence |
| D. | Use the Zip code of the | Zip code | 10000 |
| | community townhall or the | | |
| | like | | |
| | | Our Community's Contact | |
| | | Person is | |
| E. | Contact for Community | Name | William Johnson |
| F. | | Telephone | (555) 555-5555 |
| | | Email | Captain America@USA.com |
| G. | Today's Date | Date | May 1, 2004 |
| H. | On a scale from 1 to 10 (10 | 1 = low 2, 3, 4, 5, 6, 7, 8, 9, 10 = high | |
| | is highest or best), | | |
| | How prepared is your | → | 5 |
| | community regarding | | |
| | terrorism? | | |

After filling out the information page, the member of Townsville who is using the system would proceed to the scorecard (as depicted in FIG. 3). The scorecard will direct the user to the various categories having the series of questions for the user to answer. The risk assessment evaluation is the first portion of the scorecard that the user completes. The user answers the questions by following the given directions, and the scores are generated automatically due to the formulas within the system. An example of the completed risk assessment evaluation sheet is below.

1. COMMUNITY RISK ASSESSMENT EVALUATION

| | | | |
|---|---|---|---|
| Step 1 | Determine the size of your community and Place a 1 (number 1) in | | Score 2 |
| | the appropriate box leaving other boxes blank; | | |
| | Size of Community | | |
| A. | 49,999 People or less | | |
| B. | 50,000 to 99,999 People | | |
| C. | 100,000 to 499,999 People | 1 | |
| D. | 500,000 to 999,999 People | | |
| E. | 1,000,000 to 2,499,999 People | | |
| F. | 2,500,000 People or more | | |
| Step 2 | Determine Mission/Industry of Businesses in your community and | | Score 1 |
| | place percentages based on your community's employment ratio of | | |
| | each in the box; | | |
| | Business and Industry of Community | | |
| A. | Small Local Cottage Businesses | 50% | |
| B. | Businesses & Corporations with international customers or | 30% | |
| | suppliers, Local Government, Food Services, Business and | | |
| | Corporations with over $100 million in revenue per year | | |
| C. | Minor Electrical and Fossil Fuel Interchanges and Hubs/network | 10% | |
| | hubs, Biomedical Equipment, State Governmental, National | | |
| | Finance & Banking, and Emergency Services Organizations (not | | |
| | deployed) | | |
| D. | Moderate Electrical & Fossil Fuel Interchanges/network hubs, | 10% | |
| | Medical Goods Supply, International Finance & Banking, | | |
| | Transportation, Military Weapons or Products, Food Production, | | |
| | Law Enforcement, Emergency Services (deployed), or | | |
| | Biotechnology | | |
| E. | Major Electrical, Fossil Fuel or Nuclear Interchanges/Network | 0% | |
| | Hubs, Mass Media, Pharmaceuticals or vaccine production, Food | | |
| | Processing & Central Storage, Healthcare, Dental, Veterinarian | | |
| | Facilities and Medical Laboratories, Mail & Delivery Services, | | |
| | National Level Government, Armed Services | | |
| | SHOULD SUM TO 100% | 100% | |
| Step 3 | Determine high profile areas and or facilities associated with your | | Score 4 |
| | community and insert a 1 (number 1) for Yes and a 0 (number 0) for | | |
| | No as appropriate; | | |
| | High Profile Areas or Facilities of the Community | | |
| A. | Does your community have a regional airport? | 1 | |
| B. | Does your community have an international airport? | 0 | |
| C. | Does your community have a unique production or service | 0 | |
| | capability (e.g. pharmaceuticals/vaccines) or unique manufacturing | | |
| | ability (e.g. chemical detection device) that counters terrorist efforts | | |
| | in the areas of chemical, biological, radiological, nuclear, or | | |
| | explosives abilities? | | |
| D. | Is your community located within 30 miles of a federal installation | 1 | |
| | (e.g. armed services, law enforcement power plant, ordinance | | |
| | production, storage)? | | |
| E. | Is your community located within 30 miles of a state installation | 1 | |
| | (e.g. armed services, law enforcement power plant, government | | |
| | activities, storage)? | | |
| F. | Does your community contain or is it located within 30 miles from | 1 | |
| | a facility or place of symbolic significance (e.g. national monument | | |
| | [Statue of Liberty] or building [Sears Tower] or topography [Great | | |
| | Lakes])? | | |
| Step 4 | Determine Traveler/Visitor Volume for your community per year | | Score 2 |
| | and place a 1 (number 1) in the appropriate box leaving other boxes | | |
| | blank; | | |
| | Traveler/Visitor Volume of the Community | | |
| A. | 49,999 People or less | | |
| B. | 50,000 to 99,999 People | | |
| C. | 100,000 to 499,999 People | 1 | |
| D. | 500,000 to 999,999 People | | |
| E. | 1,000,000 to 2,499,999 People | | |
| F. | 2,500,000 People or more | | |
| Step 5 | Determine the volume of raw and finished material goods moving | | Score 4 |
| | through or destined to your community and place a 1 (number 1) in | | |
| | the appropriate box leaving other boxes blank; | | |
| | Raw Material Volume | | |
| A. | Less than 1 million metric tons | | |
| B. | 1 million to 10 million metric tons | | |
| C. | 10 to 25 million metric tons | | |
| D. | 25 to 50 million metric tons | | |
| E. | 50 to 100 million metric tons | 1 | |
| F. | Over 100 million metric tons | | |
| | When you have completed the 5 steps for risk assessment, Click | | |
| | Here | | |

When the user is finished with the risk assessment evaluation, he/she returns to the scorecard and continues to the screening and identification evaluation. Again, the user answers the questions and the scores are figured by the system. An example of Townsville's screening and identification evaluation is below.

2. COMMUNITY SCREENING AND IDENTIFICATION EVALUATION

| | | | |
|---|---|---|---|
| Step 1 | Determine the Potential Ability for Screening and Identification of Terrorist Threat | | Score 6 |
| | Agents or Materials in your Community by placing approximate percentages for | | |
| | each question in each appropriate box; | | |
| | Ability for Screening and Identification for the Community | | |
| A. | What is the percentage of first responders (e.g. police, fire, rescue, EMTs) in your | 80% | |
| | community that are trained in the identification of chemical, biological or | | |
| | radiological signs and symptoms presented by patients/victims? | | |
| B. | What is the percentage of primary care providers (e.g. family practice, internal | 75% | |
| | medicine, pediatrics, and OB/GYN physicians) in your community that are trained | | |
| | in the identification of chemical, biological or radiological signs and symptoms | | |
| | presented by patients/victims? | | |
| C. | What is the percentage of staff of emergency rooms, urgent care centers, and other | 90% | |
| | initial points of healthcare access in your community that are trained in the | | |
| | identification of chemical, biological and radiological signs and symptoms | | |
| | presented by patients/victims? | | |
| D. | What is the percentage of veterinarians in your community that are trained in the | 40% | |
| | identification of chemical, biological or radiological signs and symptoms affecting | | |
| | animal, livestock, and pet populations in your area? | | |
| E. | What percentage of the general population in your community know what basic | 20% | |
| | signs and symptoms to watch out for regarding chemical, biological and | | |
| | radiological agents to include the reporting and notification procedures of these | | |
| | potential threats? | | |
| F. | What percentage of the general population in your community knows how to | 25% | |
| | identify and report suspicious individuals, packages or materials? | | |
| Step 2 | Determine the Potential and Speed of Screening and Identification of Chemical, | | Score 5 |
| | Biological, and Radiological Victims in your Community by placing a 1 (number 1) | | |
| | for Yes and a 0 (number 0) for No for each question in each appropriate box; | | |
| | Speed of Screening and Identification for the Community | | |
| A. | Does your community have access within one hour to a microbiology laboratory | 1 | |
| | (e.g. state lab or hospital lab) that is linked to the Laboratory Response Network? | | |
| B. | Does your community veterinarian systems link to human systems for purposes of | 1 | |
| | early warning of chemical, biological or radiological agents? | | |
| C. | Does your community have chemical detection devices in areas of high volume | 0 | |
| | traffic (people and materials)? | | |
| D. | Does your community have radiation detection devices in areas of high volume | 0 | |
| | traffic (people and materials)? | | |
| E. | Does your community have a bomb detection or disposal unit available within 1 | 1 | |
| | hour? | | |
| F. | Does your community have computer technology enabled screening of persons at | 0 | |
| | high volume traffic areas such as image recognition and matching systems? | | |
| Step 3 | Determine the Integration of State and Federal Resources for Screening and | | Score 2 |
| | Identification of Terrorist Threats in your Community by placing a 1 (number 1) for | | |
| | Yes and a 0 (number 0) for No for each question in each appropriate box; | | |
| | Integration of State and Federal Resources to the Community | | |
| A. | Is your community linked to the National Electronic Disease Surveillance System of | 1 | |
| | the CDC? | | |
| B. | Has your community planned or discussed issues regarding terrorism to the state | 1 | |
| | agency responsible for terrorism preparation and deterrence in the past year? | | |
| | When you have completed the 3 steps for screening and identification, Click | | |
| | Here | | |

When the user is finished with the screening and identification evaluation, he/she returns to the scorecard and continues to the prevention, deterrence, and planning evaluation. Again, the user answers the questions and the scores are figured by the system. An example of Townsville's prevention, deterrence, and planning evaluation is below.

3. PREVENTION, DETERRENCE & PLANNING EVALUATION

| | | | |
|---|---|---|---|
| Step 1 | Determine the Ability to Prevent & Deter Acts of Terrorists in your Community by | | Score 3 |
| | placing approximate percentages for each Question in each box | | |
| | Ability to Prevent & Deter in the Community | | |
| A. | What percentage of your local law enforcement team has been trained to identify | 50% | |
| | terrorist type threats and attacks? | | |
| B. | What percentage of the law enforcement in your community have been trained and | 50% | |
| | educated concerning terrorist related threats and issues such as right to privacy, | | |
| | extended powers of law enforcement and the like? | | |
| C. | What percentage of your community's associations such as Neighborhood Watch, | 10% | |
| | Civil Defense, Rotary Club, Kiwanis Club, and the like have been educated and | | |
| | trained on reporting procedures regarding terrorism? | | |
| D. | What percentage of the local and/or regional media, journalists, etc., have been | 10% | |
| | trained on terrorism issues regarding the media and been briefed on your local | | |
| | community's terrorism plan? | | |
| E. | What percentage of your community's businesses and industry have been trained | 10% | |
| | and briefed to include reporting procedures regarding terrorism issues? | | |
| Step 2 | Determine the Level of Planning in the Community Concerning Terrorism by | | Score 6 |
| | placing a 1 (number 1) for Yes and 0 (number 0) for No in each box | | |
| | Level of Planning | | |
| A. | A community terrorism preparation, deterrence and response plan has been | | |
| | developed regarding the following: | | |
| | For administering medications and vaccines to the community's population? | 1 | |
| | For decontamination of the population, property, and land within the | 1 | |
| | community? | | |
| | The population knows what to do and when to do it when a terrorist type | 0 | |
| | incident occurs | | |
| | The integration and use of natural resources such as the Strategic National | 1 | |
| | Stockpile, National Guard & Reserve, CDC, FEMA, etc.? | | |
| B. | A community terrorism preparation, deterrence and response plan has been | | |
| | developed and includes the following: | | |
| | A Mission and Vision for the Plan? | 1 | |
| | Goals linked to Responsible Agencies? | 1 | |
| | Objectives of each goal that are measurable that are linked to responsible | 0 | |
| | individuals in the community? | | |
| | Action plans of each objective that are measurable with progress regularly | 0 | |
| | reported to community leaders? | | |
| | A regular reporting system of progress in meeting goals, objectives and action | 0 | |
| | planning steps is in place and briefed to senior community leaders regarding | | |
| | community terrorism preparedness, deterrence and response? | | |
| | Input and acceptance by key community groups? | 0 | |
| | A plan to communicate the necessary steps, actions, and application of the plan | 1 | |
| | to the community? | | |
| C. | Does your community have a central person or group that has the authority for | 1 | |
| | overall leadership decisions, command and control, and resource allocation during | | |
| | preparation, deterrence, and response to terrorist threats? | | |
| D. | Does your community have a central person or group that has the authority and | 1 | |
| | responsibility to coordinate, report and activate federal and state terrorism planning | | |
| | and action agencies? | | |
| E. | Is there a clearly defined and designated person or persons in your community with | 1 | |
| | the authority and responsibility to make medical decisions regarding coordination, | | |
| | reporting, and response for community terrorism preparation, deterrence, and | | |
| | response efforts? | | |
| Step 3 | Determine the Extent of Planning in the Community Concerning Terrorism by | | Score 7 |
| | placing a percentage in each box | | |
| | Level and Extent of Planning | | |
| A. | Please complete the next set of questions | | |
| | Is your community? 1 = Rural; 2 = Suburban; 3 = Urban | 1 | |
| | How many people (number of people) are in your community? | 100,000 | |
| | How would you categorize the level of terrorism preparation planning in your | 2 | |
| | community? Use: 1 = no planning; 2 = planning documents complete; 3 = all of 2 | | |
| | and exercise of plan completed in past 12 months | | |
| | What is the level of terrorism response training in your community? Use 1 = none; | 3 | |
| | 2 = decontamination teams, material distribution teams, and medical teams | | |
| | trained; 3 = all of 2 and physicians and other providers trained and | | |
| | simulation/practice has been exercised in last 12 months | | |
| | What level of coordination has been done with your local hospital and the | 3 | |
| | medical supply operation for pharmaceuticals with regard to terrorism response? | | |
| | Use: 1 = no coordination completed; 2 = safety levels of CDC identified materials | | |
| | identified by location and quantity; 3 = all of 2 and emergency access roster | | |
| | completed for each location | | |
| | What level of coordination between the community and the local hospital has | 3 | |
| | been done regarding terrorism preparation? Use: 1 = No; 2 = Moderate; 3 = Fully | | |
| | to include list and access of medical material available for first response use | | |
| | How far in MILES are you from the nearest commercial airport? | 20 | |
| | QUESTIONS B, C, AND E - DO NOT REQUIRE YOU TO ANSWER - DO | | |
| | NOT ANSWER QUESTIONS B, C, AND E | | |
| B. | What percent of your community population could you administer medications and | 100% | |
| | vaccines to in a period of approximately 3 days (68-76 hours) - THIS ANSWER | | |
| | COMES FROM THE WORKSHEET | | |
| C. | What percentage of your community could you decontaminate within | 82% | |
| | approximately 3 days (68-76 hours) - THIS ANSWER COMES FROM THE | | |
| | WORKSHEET | | |
| D. | Approximately how many hospital beds are readily available within 1 hour of your | 150 | |
| | community? | | |
| E. | What percentage of people in your community will be admitted to an available | 39% | |
| | hospital bed within 72 hours based on the worksheet scenario? - THIS ANSWER | | |
| | COMES FROM THE WORKSHEET | | |
| | When you have completed the 3 steps for Prevention, Deterrence and Planning | | |
| | Evaluation, Click Here | | |

When the user is finished with the prevention, deterrence and planning evaluation, he/she returns to the scorecard and continues to the training, awareness, and application evaluation. Again, the user answers the questions and the scores are figured by the system. An example of Townsville's training, awareness, and application evaluation is below.

4. TRAINING, AWARENESS & APPLICATION

| | | | |
|---|---|---|---|
| Step 1 | Determine the available level of training in the community by placing a 1 | | |
| | (number 1) for Yes and a 0 (Number 0) for No in the appropriate box | | |
| | Training in the Community | | Score 10 |
| A. | Are there training on terrorism (appropriate types of training) and agency specific | | |
| | equipment required and completed, related to the following areas in your | | |
| | community for: | | |
| | Law enforcement? | 1 | |
| | First Responders (Police, Fire, Rescue, EMTs)? | 1 | |
| | Primary Care Providers (Physicians to include Emergency Rooms and | 1 | |
| | Urgent Care Centers)? | | |
| | Nurses and other healthcare related personnel? | 1 | |
| | Local officials (elected, appointed and hired to include judges? | 1 | |
| | The General Population in your community? | 1 | |
| B. | Have individuals been assigned to teams and has there been training on medical | 1 | |
| | material (pharmaceuticals, medical supplies, etc...) handling and distribution | | |
| | within your community? | | |
| C. | Have individuals been assigned to teams and has there been training on | 1 | |
| | decontamination procedures within your community? | | |
| D. | Have simulation exercises or practices been conducted on the following areas in | | |
| | your community in the past 12 months?: | | |
| | A chemical terrorist attack to include appropriate decontamination, | 1 | |
| | distribution of medical supplies and equipment, use of medical resources as | | |
| | appropriate, and security of the community? | | |
| | A biological terrorist attack to include appropriate decontamination, | 1 | |
| | distribution of medical supplies and equipment, use of medical resources as | | |
| | appropriate, and security of the community? | | |
| | A radiological terrorist attack to include appropriate decontamination, | 1 | |
| | distribution of medical supplies and equipment, use of medical resources as | | |
| | appropriate, and security of the community? | | |
| | An explosives terrorist attack to include appropriate decontamination, | 1 | |
| | distribution of medical supplies and equipment, use of medical resources as | | |
| | appropriate, and security of the community? | | |
| Step 2 | Determine the level of preparedness application in the community by placing an | | |
| | appropriate percentage in each box below | | |
| | Training in the Community | | Score 7 |
| A. | What percentage of the following groups has been vaccinated against category A | | |
| | & B pathogens (CDC Categories of highest level threat pathogens)? | | |
| | First Responders (Police, Fire, Rescue, EMTs)? | 100% | |
| | Law enforcement officials? | 100% | |
| | Primary Care Providers (Physicians to include Emergency Rooms and | 100% | |
| | Urgent Care Centers)? | | |
| | Nurses and other healthcare related personnel? | 100% | |
| | Local officials (elected, appointed and hired to include judges)? | 40% | |
| | Utility Workers such as water treatment, sewage, and trash? | 50% | |
| | The General Population in your community? | 35% | |
| B. | What percentage of healthcare related organizations (hospitals, physician offices, | 33% | |
| | urgent care centers, etc . . . ) are involved in community terrorism preparation, | | |
| | deterrence and response efforts? | | |
| | When you have completed the 2 steps for the Training, Awareness and | | |
| | Application Evaluation, Click Here | | |

When the user is finished with the training, awareness, and application evaluation, he/she returns to the scorecard and continues to the activation and response evaluation. Again, the user answers the questions and the scores are figured by the system. An example of Townsville's activation and response evaluation is below.

5. ACTIVATION AND RESPONSE

| | | | |
|---|---|---|---|
| Step 1 | Determine the planning level for activation and response by placing a 1 | | |
| | (number 1) for Yes and a 0 (Number 0) for No in the appropriate box | | |
| | Activation & Response | | Score 23 |
| A. | The community has a plan for activation and response to terrorism events | | |
| | according to the following: | | |
| | Who and how to notify of the local, state and federal authorities? | 1 | |
| | Thresholds for activation and response based on screening and | 1 | |
| | identification in the community? | | |
| | Ability to set secure parameters or boundaries around the impacted area to | 0 | |
| | include quarantine? | | |
| | Notification of key community people such as: | | |
| | Medical Material distribution teams? | 1 | |
| | Decontamination Teams? | 0 | |
| | Emergency Response Teams? | 1 | |
| | Medical Teams? | 1 | |
| | Law Enforcement Teams? | 1 | |
| | National Guard or Reserve Military Units? | 0 | |
| B. | A notification system is in place with contact information and a responsible | 1 | |
| | person(s) to implement the notification system? | | |
| C. | A contact notification list has been developed to include: | | |
| | Local Hospital Officials? | 1 | |
| | Local Public or Community Health Officials? | 1 | |
| | Local Officials? | 1 | |
| | State Officials? | 1 | |
| | Federal Officials? | 0 | |
| | Healthcare Providers in the area? | 0 | |
| | The Media? | 1 | |
| D. | The following groups know what to do upon terrorism incident notification? | | |
| | Medical Material distribution teams? | 1 | |
| | Decontamination Teams? | 1 | |
| | Emergency Response Teams? | 1 | |
| | Medical Teams? | 1 | |
| | Law Enforcement Teams? | 1 | |
| | National Guard or Reserve Military Units? | 0 | |
| | Local Hospital Officials? | 1 | |
| | Local Public or Community Health Officials? | 1 | |
| | Local Officials? | 1 | |
| | State Officials? | 1 | |
| | Federal Officials? | 0 | |
| | Healthcare Providers in the area? | 0 | |
| | The Media? | 0 | |
| E. | On a scale from 1 to 5, how fast can your community activate and respond to | 2 | |
| | terrorist incidents? (1 = 24 hours or more, 2 = less than 24 hours, 3 = 16 hours | | |
| | or less, 4 = 8 hours or less, or 5 = 4 hours or less) | | |
| | When you have completed the step for the Activation and Response | | |
| | Evaluation, Click Here | | |

When the user is finished with the activation and response evaluation, he/she returns to the scorecard and continues to the leadership, authority and communication evaluation. Again, the user answers the questions and the scores are figured by the system. An example of Townsville's activation and response evaluation is below.

6. LEADERSHIP, AUTHORITY & COMMUNICATION

| | | | |
|---|---|---|---|
| Step 1 | Determine the leadership ability to deal with terrorism incidents in the | | |
| | community by placing a 1 (number 1) for Yes and a 0 (Number 0) for No in the | | |
| | appropriate box | | |
| | Activation & Response | | Score 16 |
| A. | A secure communication environment is available locally for: | | |
| | Encrypted Video Transmission and Reception? | 0 | |
| | Encrypted Audio Transmission and Reception? | 0 | |
| | Encrypted Data Transmission and Reception? | 0 | |
| B. | Information, planning documents, and leadership authority information has been | 1 | |
| | sent and filed at appropriate state and federal agencies? | | |
| C. | Leadership team has completed Terrorism Self-Study and Incident Management | 0 | |
| | Systems Courses? | | |
| | Rest of Score Taken from Earlier Questions | | |
| | When you have completed the step for the Leadership, Authority and | | |
| | Communication Evaluation, Click Here | | |

Upon completion of the leadership, authority, and communication evaluation, the user has completed the domains (preparation and implementation) of the scorecard. The user then continues to the scorecard summary sheet, which contains the scores for each of the categories, the domains, and the combined score. Townsville's scorecard summary sheet is depicted below. It is to be understood that the formulas within the system are adapted to generate the scores of the community based on the responsive answers/numerical values which the user(s) provides.

[image]

Generally, the system may optionally also allow the user to register its community scorecard with a central database. This database may allow the user to compare the community's level of preparedness, deterrence, and response capability with other communities with similar and/or different demographics. This database may also allow the user to compare the community's original score with a later score that is figured at a time after the community has implemented its plan of action.

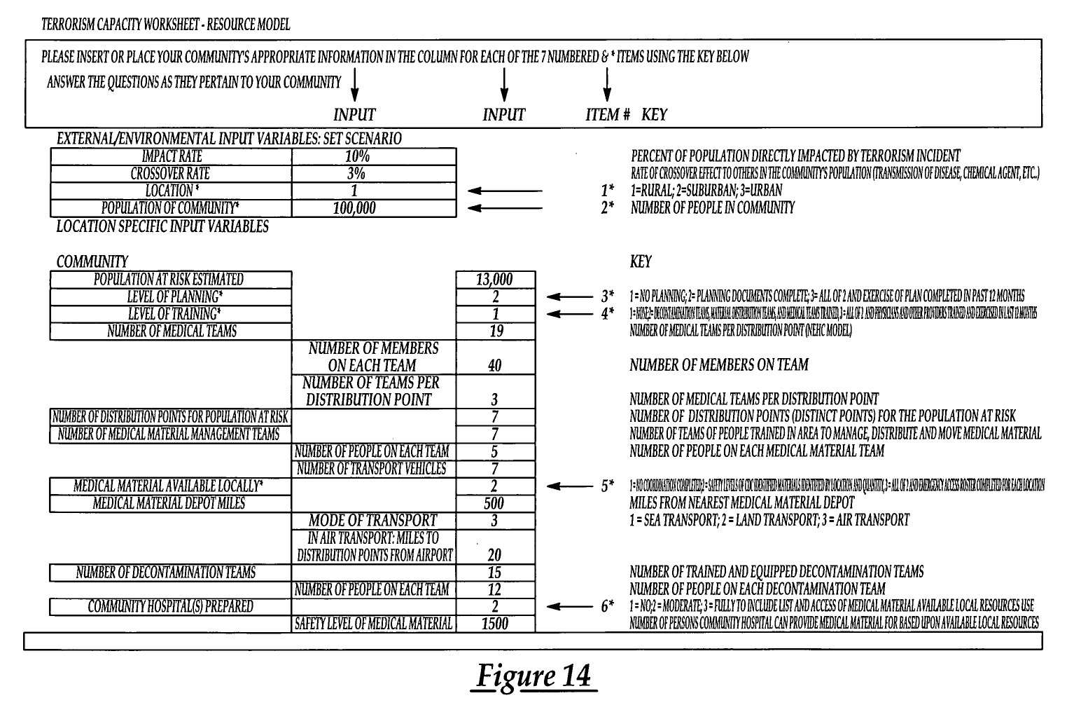

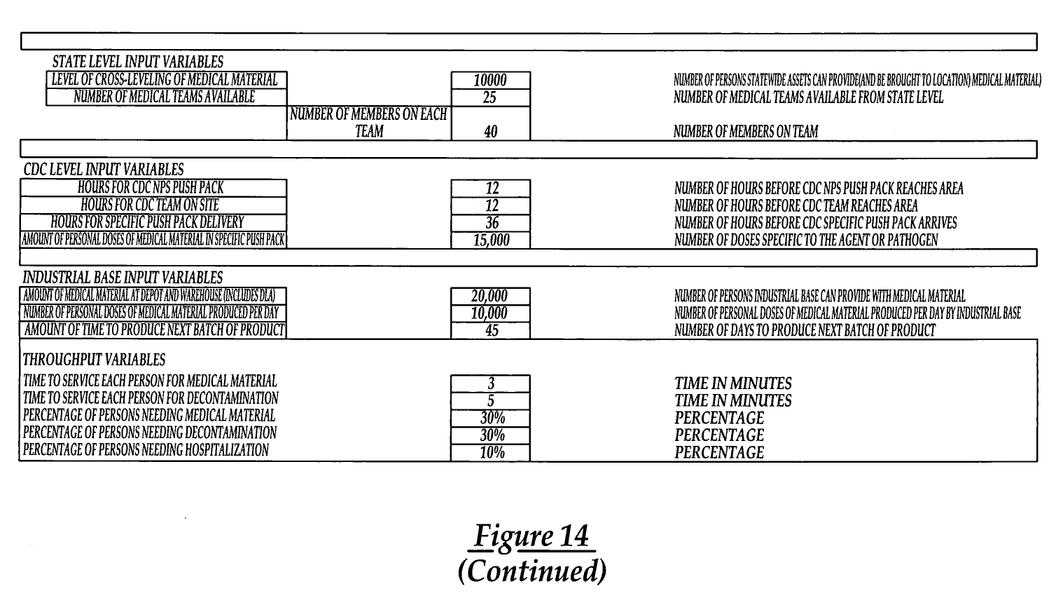

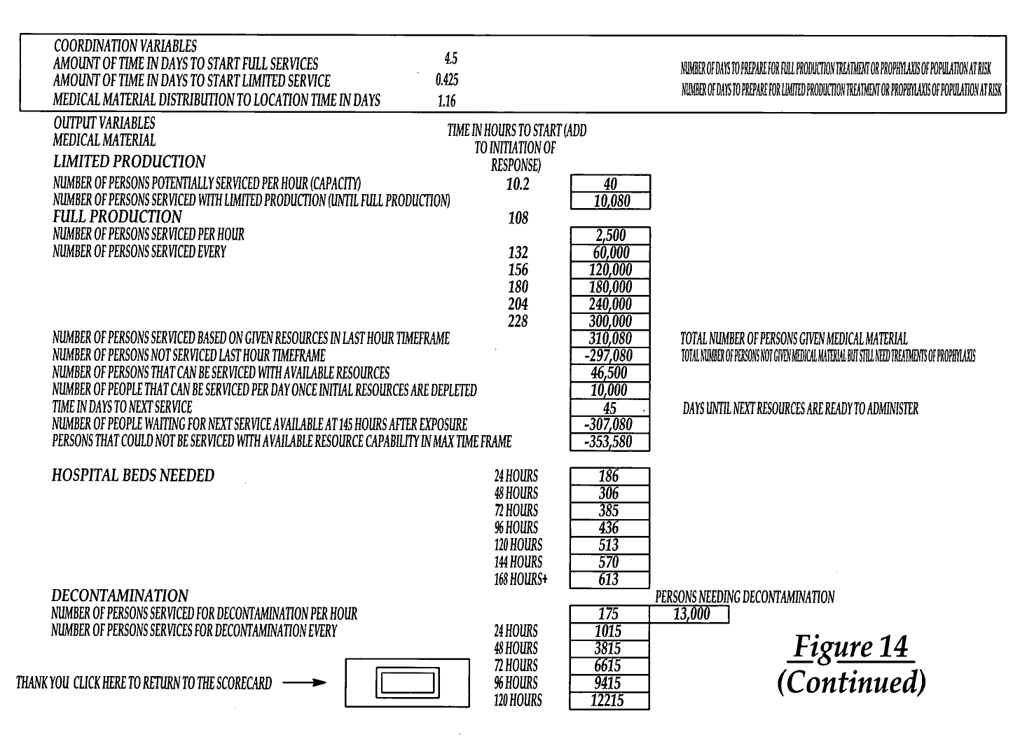

The system may further include a capacity worksheet module that allows the user to compare the community's score(s) to a fictitious/simulated community impacted by the particular crisis situation being assessed. A non-limitative example of a capacity worksheet is depicted in FIG. 14.

While several embodiments have been described in detail, it will be apparent to those skilled in the art that the disclosed embodiments may be modified. Therefore, the foregoing description is to be considered exemplary rather than limiting.

What is claimed is:

1. A method for assessing a community's preparedness, deterrence, and response capability for handling crisis situations, the method comprising the steps of:
providing numerical values that represent answers to a series of questions divided into a crisis situation preparation domain and a crisis situation implementation domain;
determining a combined score of the domains based on the numerical values provided; and
ranking the combined score on a scale ranging between poor capability and very good capability for handling crisis situations.

2. The method as defined in claim 1, further comprising the step of determining at least one of a present plan and a future plan for the community to adjust their capability for handling crisis situations based on the ranking of the combined score.

3. The method as defined in claim 2, wherein the at least one of the present plan and the future plan comprises at least one of goals, objectives, actions, and target completion dates for the community to follow in order to adjust their capability for handling crisis situations.

4. The method as defined in claim 3, further comprising the step of generating at least one report based on the at least one of goals, objectives, actions, and target completion dates.

5. The method as defined in claim 4, further comprising the step of communicating the at least one report to at least one appropriate level of leadership.

6. The method as defined in claim 5 wherein the at least one appropriate level of leadership comprises at least one of police personnel, fire fighters, medical professionals, hospital personnel, public health officials, emergency response teams, and government officials.

7. The method as defined in claim 5, further comprising the step of following up with the at least one appropriate level of leadership after a period of time to rank the community's progress in adjusting their capability for handling crisis situations.

8. The method as defined in claim 2, further comprising the step of using the combined score to determine a resource requirement sheet for the at least one of the present plan and the future plan for adjusting the community's capability for handling crisis situations.

9. The method as defined in claim 1 wherein the crisis situations comprise at least one of acts of terrorism/war, natural disasters, and outbreaks of disease.

10. The method as defined in claim 1 wherein the crisis situation preparation domain includes categories comprising at least one of community risk assessment; screening and identification for a potential threat of crisis situations; ability to prevent, deter and plan for crisis situations; and available level of training, awareness and application in the community.

11. The method as defined in claim 10, further comprising the steps of:
determining a score for each of the categories within the crisis situation preparation domain; and
determining an urgency of activity required by the community by comparing the score of the community risk assessment category to a community composite risk assessment table.

12. The method as defined in claim 1 wherein the crisis situation implementation domain includes categories comprising at least one of current planning level for activation and response to crisis situations; and current leadership, authority and communication ability within the community to deal with crisis situations.

13. The method as defined in claim 12, further comprising the step of determining a score for each of the categories within the crisis situation implementation domain.

14. The method as defined in claim 1 wherein the community's preparedness, deterrence, and response capability for handling two or more crisis situations are assessed simultaneously.

15. The method as defined in claim 1 wherein two or more communities' preparedness, deterrence, and response capability for handling crisis situations are assessed simultaneously.

16. The method as defined in claim 1 wherein the numerical values are recorded on a scorecard adapted to determine the combined score.

17. The method as defined in claim 1 wherein the series of questions varies in accordance with the crisis situation being assessed.

18. The method as defined in claim 1, further comprising the step of comparing the combined score with a simulation scenario of a community impacted by a similar crisis situation.

19. The method as defined in claim 1, further comprising the step of comparing the combined score with a combined score of a second community.

20. A method for assessing a community's preparedness, deterrence, and response capability for handling crisis situations, comprising the steps of:
providing numerical values that represent answers to a series of questions divided into a crisis situation preparation domain and a crisis implementation domain, each of the domains having one or more categories therein;
determining a score for each of the categories within the crisis situation preparation domain and the crisis implementation domain based on the numerical values provided;
determining a combined score of the domains using the scores for each of the categories;
ranking the combined score on a scale ranging between poor capability and very good capability for handling crisis situations; and
determining at least one of a present plan and a future plan for the community to adjust their capability for handling crisis situations based on the ranking of the combined score.

21. The method as defined in claim 20, wherein the at least one of the present plan and the future plan comprises at least one of goals, objectives, actions, and target completion dates for the community to follow in order to adjust their capability for handling crisis situations.

22. The method as defined in claim 20, further comprising the steps of:
generating at least one report based on the at least one of goals, objectives, actions, and target completion dates; and
communicating the at least one report to at least one appropriate level of leadership.

23. The method as defined in claim 22 wherein the at least one appropriate level of leadership comprises at least one of police personnel, fire fighters, medical professionals, hospital personnel, public health officials, emergency response teams, and government officials.

24. The method as defined in claim 22, further comprising the step of following up with the at least one appropriate level of leadership after a period of time to rank the community's progress in adjusting their capability for handling crisis situations.

25. A system for assessing a community's preparedness, deterrence, and response capability for handling one or more crisis situations, comprising:
a processor;
a memory coupled to the processor; and
a computer program application located within the memory and executable by the processor, the computer program including an analysis scorecard adapted to receive numerical values that represent answers to a series of questions pertaining to one or more crisis situations, and to produce at least one score based on those values, the at least one score representing the community's preparedness, deterrence and response capability for handling the one or more crisis situations.

26. The system as defined in claim 25 wherein the score is adapted to help the community determine at least one of a present plan and a future plan to adjust their capability for handling the one or more crisis situations.

27. The system as defined in claim 26, wherein the at least one of the present plan and the future plan is recorded in the form of a report including at least one of goals, objectives, actions, and target completion dates for the community to follow in order to adjust their capability for handling the one or more crisis situations.

28. The system as defined in claim 27 wherein the report is adapted to be communicated to at least one appropriate level of leadership.

29. The system as defined in claim 28 wherein the at least one appropriate level of leadership comprises at least one of police personnel, fire fighters, medical professionals, hospital personnel, public health officials, emergency response teams, and government officials.

30. The system as defined in claim 25 wherein the one or more crisis situations comprise at least one of acts of terrorism/war, natural disasters, and outbreaks of disease.

31. The system as defined in claim 25 wherein the analysis scorecard comprises a crisis situation preparation domain including categories comprising at least one of community risk assessment; screening and identification for a potential threat of crisis situations; ability to prevent, deter and plan for crisis situations; and available level of training, awareness and application in the community.

32. The system as defined in claim 31 wherein an individual score is compiled for the community risk assessment category and wherein the individual score is adapted to help determine an urgency of activity required by the community.

33. The system as defined in claim 25 wherein the analysis scorecard comprises a crisis implementation domain including categories comprising at least one of current planning level for activation and response to crisis situations; and current leadership, authority and communication ability within the community to deal with crisis situations.

34. The system as defined in claim 25 wherein the analysis scorecard is adapted to simultaneously assess the community's preparedness, deterrence, and response capability for handling two or more crisis situations.

35. The system as defined in claim 25 wherein two or more communities' preparedness, deterrence, and response capability for handling crisis situations are assessed simultaneously.

36. The system as defined in claim 25 wherein the series of questions varies in accordance with the one or more crisis situations being assessed.

37. The system as defined in claim 25 wherein the computer program application further comprises a macro resource worksheet module adapted to receive the at least one score from the analysis scorecard and to develop a resource requirement sheet for the community to use as a tool for adjusting the community's capability for handling the one or more crisis situation.

38. The system as defined in claim 25 wherein the computer program application further comprises a capacity worksheet module adapted to compare the at least one score to at least one of a simulated community impacted by the one or more crisis situation being assessed and a second community.

39. The system as defined in claim 25 wherein the computer program application further comprises a resource and publication module adapted to assist a user of the system in answering the series of questions.

40. A method for using a system for assessing a community's preparedness, deterrence, and response capability for handling crisis situations, the method comprising the steps of:
providing numerical values that represent answers to a series of questions divided into a crisis situation preparation domain and a crisis situation implementation domain;
determining a combined score of the domains based on the numerical values provided;
ranking the combined score on a scale ranging between poor capability and very good capability for handling crisis situations; and
determining at least one of a present plan and a future plan for the community to adjust their capability for handling crisis situations based on the ranking of the combined score.

41. The method as defined in claim 40 wherein the system is accessed via at least one of an Internet enabled program and a compact disc.

42. The method as defined in claim 40 wherein the at least one of the present plan and the future plan comprises at least one of goals, objectives, actions, and target completion dates for the community to follow in order to adjust their capability for handling crisis situations.

43. The method as defined in claim 42, further comprising the steps of:
generating at least one report based on the at least one of goals, objectives, actions, and target completion dates; and
communicating the at least one report to at least one appropriate level of leadership including at least one of at least one of police personnel, fire fighters, medical professionals, hospital personnel, public health officials, emergency response teams, and government officials.

44. The method as defined in claim 40 wherein the system comprises an analysis scorecard adapted to receive the numerical values to produce the score.

45. The method as defined in claim 40 wherein the system further comprises a database for comparing the community's score to at least one of the community's progress and a second community's score.

46. The method as defined in claim 40 wherein a user of the system receives an updated database periodically.
